(19) United States
(12) Patent Application Publication
(10) Pub. No.: US 2026/0179033 A1
(43) Pub. Date: Jun. 25, 2026

(54) CONTENT DISTRIBUTION SERVICE MANAGEMENT SYSTEM AND METHOD THEREFOR

(71) Applicant: CANON KABUSHIKI KAISHA, Tokyo (JP)

(72) Inventor: TAKESHI ISHIKURA, Tokyo (JP)

(21) Appl. No.: 19/408,111

(22) Filed: Dec. 3, 2025

(30) Foreign Application Priority Data
Dec. 24, 2024 (JP) 2024-227751

(51) Int. Cl. G06Q 10/087; G06Q 10/02; H04N 21/478

(52) U.S. Cl. CPC G06Q 10/087; G06Q 10/02; H04N 21/478

(57) ABSTRACT

A method for distributing content includes executing, based on receipt of a new reservation, a process of arranging delivery of supplies and consumables for the new reservation for an experiential content viewing room associated with the new reservation, and receiving information about reserved content to perform distribution control of content data corresponding to the content information.

### FIELD OF THE TECHNOLOGY

The present disclosure relates to a technique applied to a video distribution system for providing various kinds of video content to a subscriber, and a method for the video distribution system.

### DESCRIPTION OF THE RELATED ART

Conventionally, there are services that distribute videos to a subscriber's personal computer, smartphone, television, etc., via the Internet. In addition, head-mounted displays, etc., capable of playing three-dimensional content and virtual reality (VR) content have been used by viewers.

Movie theaters offer an immersive cinema experience using in-theater equipment that enables viewers to have an experience referred to as four-dimensional experience (4DX), such as wind and mist, in synchronization with screen images. Japanese Unexamined Patent Application Publication No. 2017-530783 describes a cinema projection technology using a special chair relating to the 4DX.

Currently, subscribers who receive video distribution via the Internet with their own terminals do not have such equipment as the movie theaters have. The subscribers can view special content only by using head-mounted displays.

The content is the same as what is shown in the movie theaters. Thus, it is desirable that the subscribers be able to enjoy the experiential viewing.

### SUMMARY

According to an aspect of the present disclosure, a method for distributing content includes executing, based on receipt of a new reservation, a process of arranging delivery of supplies and consumables for the new reservation for an experiential content viewing room associated with the new reservation, and receiving information about reserved content to perform distribution control of content data corresponding to the content information.

Features of the present disclosure will become apparent from the following description of embodiments with reference to the attached drawings. The following description of embodiments is described by way of example.

### BRIEF DESCRIPTION OF THE DRAWINGS

FIG. 1 illustrates a system for implementing a content distribution service management system.

FIG. 2 illustrates a configuration example of hardware of the systems of the content distribution service management system.

FIG. 3 illustrates an example of module configurations implemented by software programs in each of the systems of the content distribution service management system.

FIG. 4 illustrates an example of a screen provided by a content distribution service.

FIGS. 5A to 5D illustrate examples of reservation screens for an experiential content viewing room.

FIG. 6 illustrates a sequence of processing for reserving the experiential content viewing room.

FIG. 7 illustrates a sequence of processing related to use of the experiential content viewing room.

### DESCRIPTION OF THE EMBODIMENTS

An embodiment for implementing the present disclosure will now be described with reference to the drawings.

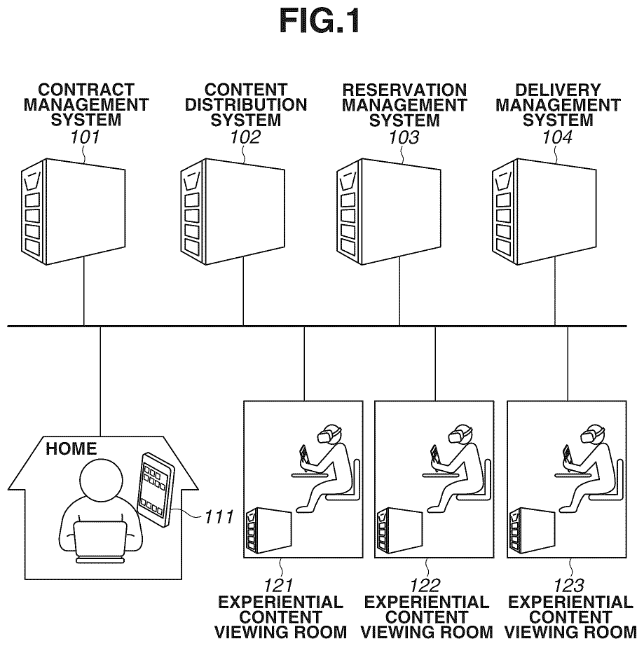

FIG. 1 illustrates a system configuration for implementing a content distribution service management system according to a first embodiment.

A contract management system 101 manages information about subscribers. A content distribution system 102 distributes content, such as videos, via a network to the users who are managed as subscribers by the contract management system 101. For example, a subscriber logs into a web service provided by the content distribution system 102 by using, for example, the subscriber's own smartphone 111 at home and receives a video to view.

In the present embodiment, the content distribution system 102 also supports distribution of experiential viewing content prepared for various videos to provide experiential video viewing. Experiential viewing refers to a viewing method of offering a viewing experience in which the user can feel the content with their entire body. This can be achieved by providing at least one of various kinds of special effects, such as mist, vibration, smell, wind, and/or visual effects, such as flash, based on scenes of the content, in addition to screen images and sound.

When the user uses one of experiential content viewing rooms 121, 122, and 123, the content distribution system 102 delivers content data about a video and the experiential viewing content to a corresponding one of the computer systems provided in the experiential content viewing rooms 121 to 123 that is used by the user.

The experiential viewing content is data necessary for experiential viewing prepared for each video. For example, the data includes the types of effects, such as wind, smell, and mist, the conditions for generating the effects in the room, and the conditions for vibrating a dedicated seat in the room.

A reservation management system 103 enables a subscriber who has a premium contract, which includes experiential video viewing, to select a video that the subscriber wishes to watch, and reserve, for example, the experiential content viewing room 121. The user can search for an experiential content viewing room located in a geographically nearby area to make a reservation at a convenient date and time. The experiential content viewing rooms are designed for small groups, such as single users or pairs, and can be used more casually than movie theaters or the like.

A delivery management system 104 arranges delivery of supplies required for experiential viewing to each of the experiential content viewing rooms 121 to 123, based on the reservation status of the experiential content viewing rooms and other factors. Specifically, consumables, and the like, for generating smell or dedicated mist are necessary to be delivered before the subscriber uses the room.

Each of the experiential content viewing rooms 121 to 123 has a computer system installed therein that receives distribution of an experiential viewing content and controls effects, such as wind, smell, mist, and vibration. In addition, a head-mounted display for viewing a video is provided in each of the experiential content viewing rooms 121 to 123. The subscriber can also bring their own head-mounted display and connect the head-mounted display to the computer system in an experiential content viewing room to view a video.

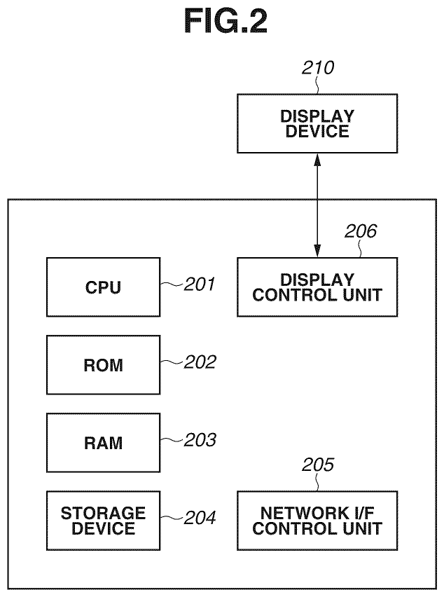

FIG. 2 illustrates an example of a hardware configuration of the contract management system 101, the content distribution system 102, the reservation management system 103, the delivery management system 104, and the smartphone 111. The contract management system 101, the content distribution system 102, the reservation management system 103, and the delivery management system 104 can be implemented by cloud computing technology, where these systems are considered information processing apparatuses.

A central processing unit (CPU) 201 executes software programs of and that control the systems of the content distribution management service system. A read-only memory (ROM) 202 stores a boot program, fixed parameters, etc. A random-access memory (RAM) 203 is used, for example, for storing programs and temporary data when the CPU 201 controls the information processing apparatus. A storage device 204 including a hard disk drive stores system software, applications, and various types of data. A network interface (I/F) control unit 205 controls transmission and reception of data to and from a network. A display control unit 206 controls display on a display device 210, and controls display of various types of information and instructions that are input by the user.

The head-mounted display used in each of the experiential content viewing rooms 121 to 123 includes, in addition to the configuration illustrated in FIG. 2, a dedicated projection unit for projecting virtual reality (VR) content and three-dimensional (3D) content onto the user's field of view. The head-mounted display includes a processor dedicated to video playback processing.

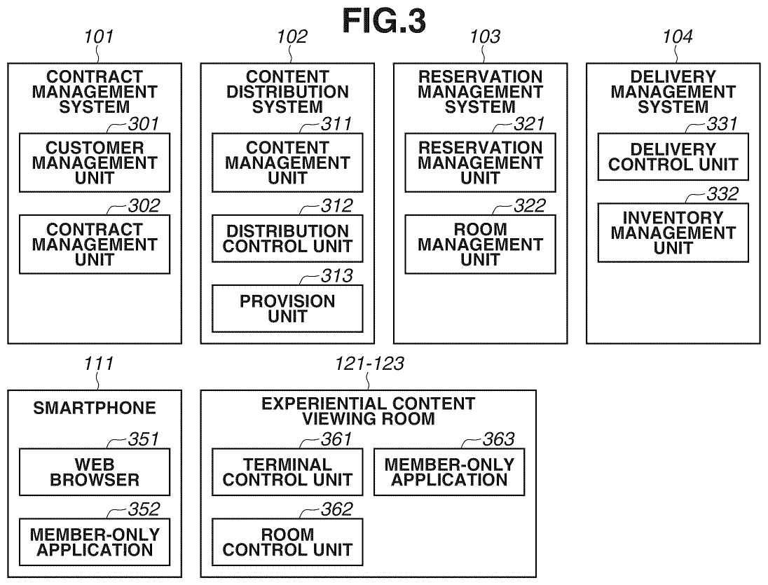

FIG. 3 illustrates module configurations implemented by software programs included in the systems of the content distribution service management system according to the present embodiment. The module configurations illustrated in FIG. 3 are examples of module configurations and are not seen to be limiting.

The contract management system 101 includes a customer management unit 301 and a contract management unit 302. The customer management unit 301 and the contract management unit 302 are examples of software module configurations that are implemented by the CPU 201 of the contract management system 101 executing dedicated programs for managing customers and contracts. The customer management unit 301 manages personal information, contract information, etc., about individual customers who subscribe to a content distribution service. The contract management unit 302 manages contract data that defines two or more contracts prepared for each customer, authorization data, such as an end-user license agreement (EULA) and the like, which is required to be provided to each customer.

The content distribution system 102 includes a content management unit 311, a distribution control unit 312, and a provision unit 313. The content management unit 311, the distribution control unit 312, and the provision unit 313 are examples of software module configurations that are implemented by the CPU 201 of the content distribution system 102 executing a dedicated program for the content distribution service. The content management unit 311 manages content data, such as movies and dramas, provided by the content distribution service. The distribution control unit 312 executes control for distributing desired content data to the customers of the content distribution service. The provision unit 313 provides various types of screens related to the content distribution service, such as a screen that will be described below, via a network, such as the Internet.

The reservation management system 103 includes a reservation management unit 321 and a room management unit 322.

The reservation management unit 321 and the room management unit 322 are examples of software module configurations that are implemented by the CPU 201 of the reservation management system 103 executing a dedicated program for managing reservations, etc., for using the content distribution service in the experiential content viewing rooms 121 to 123. The reservation management unit 321 manages reservations received from subscribers by using the information about the experiential content viewing rooms 121 to 123 and the customer information. The reservation management unit 321 issues a reservation code when a premium member completes a reservation. The room management unit 322 manages information for room management, such as the reservation statuses, the geographical information, and the room capacities of the experiential content viewing rooms 121 to 123.

The delivery management system 104 includes a delivery control unit 331 and an inventory management unit 332. The delivery control unit 331 and the inventory management unit 332 are examples of software module configurations that are implemented by the CPU 201 of the delivery management system 104 executing a dedicated program for managing supplies, consumables, etc., required for using the content distribution service in the experiential content viewing rooms 121 to 123 and executing a dedicated program for issuing delivery instructions. The delivery control unit 331 arranges delivery of necessary supplies, consumables, etc., based on reservation statuses of the experiential content viewing rooms 121 to 123. The inventory management unit 332 manages inventory statuses of supplies, consumables, etc., in the experiential content viewing rooms 121 to 123.

The smartphone 111 includes a web browser 351 and a member-only application 352. The web browser 351 and the member-only application 352 are examples of software module configurations that are implemented by executing respective software programs corresponding to the web browser 351 and the member-only application 352.

The experiential content viewing rooms 121 to 123 each include a terminal control unit 361, a room control unit 362, and a member-only application 363. The member-only application 363 is executed by a terminal, such as a head-mounted display, which shows content received from the content distribution service. The terminal control unit 361 and the room control unit 362 are examples of software module configurations that are implemented by the CPU 201 of a computer installed in a corresponding experiential content viewing room 121 to 123 executing dedicated programs for controlling room access management and four-dimensional (4D) effects, such as smell, wind, and seat vibration.

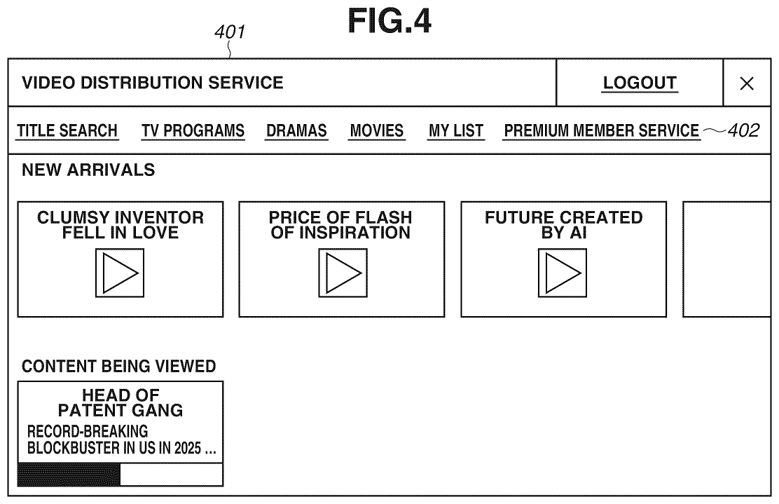

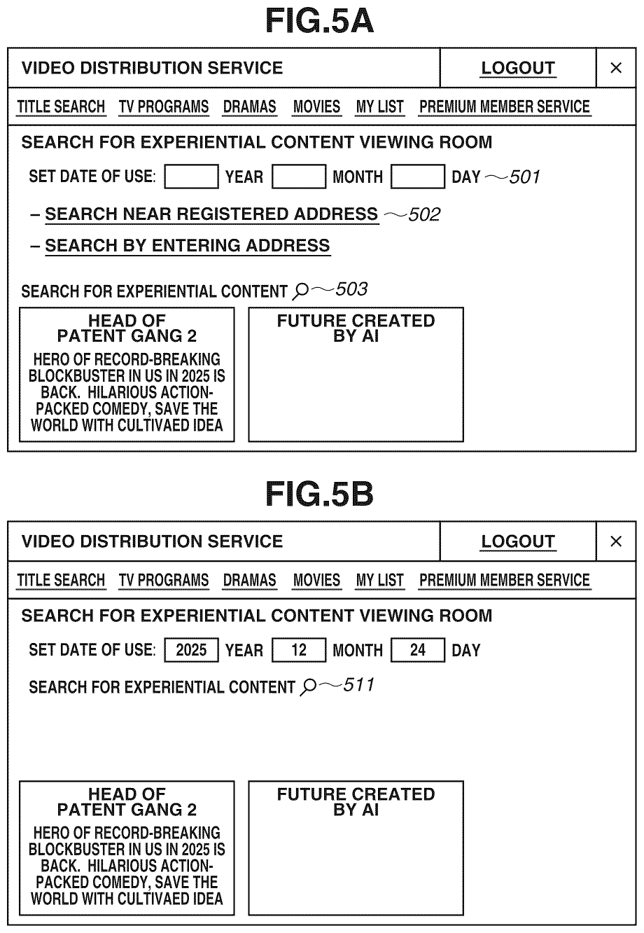

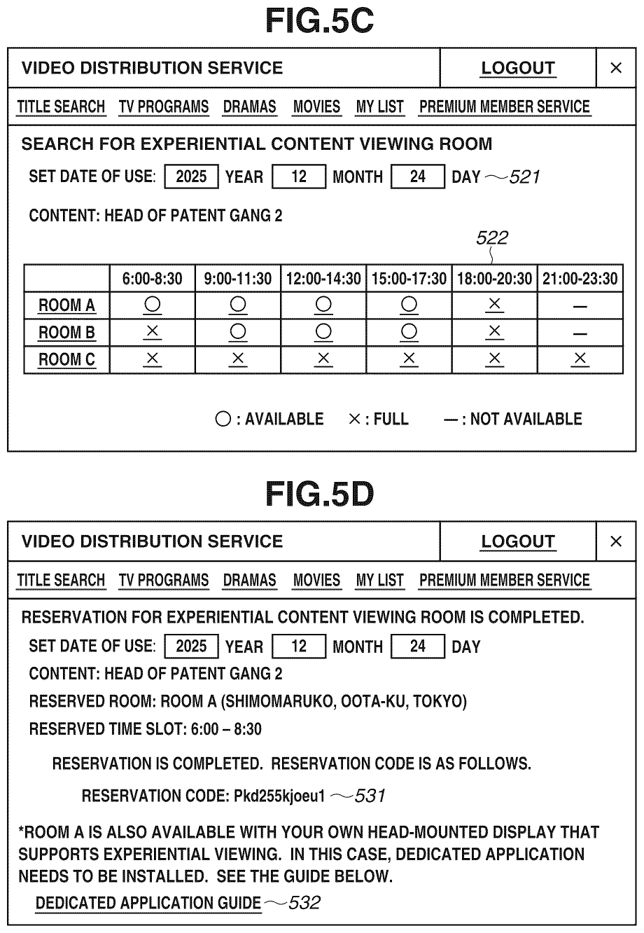

FIGS. 4 and 5A, 5B, 5C, and 5D illustrate screens for the subscriber, which are provided by the provision unit 313 of the content distribution system 102. The subscriber can access and view the screens using the web browser 351 of the smartphone 111 or the like. The member-only applications 352 and 363 can also display and operate the screens.

FIG. 4 illustrates a home screen 401 displayed on the screen for the subscriber.

FIG. 4 illustrates a state in which the subscriber has logged in. The home screen 401 enables the subscriber to search for a title or select a video from among new arrivals to view. In addition, by selecting a premium member service 402, the screen transitions to a service screen that can be used by premium members. Information about the premium members is managed by the customer management unit 301 of the contract management system 101.

FIGS. 5A to 5D illustrate service screens that can be used by the premium members. These service screens enable a premium member to make a reservation for an experiential content viewing room. The screens illustrated in FIGS. 5A to 5D are provided by the provision unit 313 of the content distribution system 102, in coordination with the reservation management system 103, based on information managed by the reservation management system 103.

FIG. 5A illustrates the top-level screen of a reservation screen. The reservation screen enables the user to set a date of use 501 and perform a search 502 for an experiential content viewing room that the user wishes to use. In addition, the user can perform a search 503 for experiential content provided by the content distribution service.

FIG. 5B illustrates a search screen for the experiential content. After the user sets the date of use, this search screen is displayed upon receiving a user instruction to perform the search 502 for an experiential content viewing room.

The user is prompted to first select content that the user wishes to view. This is because, depending on the distribution content, the number of experiential content viewing rooms that can be used are narrowed. While FIG. 5B illustrates two titles displayed on the screen as recommendations, any content can be searched for and selected by selecting a search button 511. The description of the screen transition during the search is omitted here.

FIG. 5C illustrates a screen that displays a list of experiential content viewing rooms in which the selected distribution content can be shown on a set date of use 521. The user can select any experiential content viewing room for any desired time slot on this screen. When the user selects a link of a room name (“room A”) in a table 522, specifications of the room (whether their own head-mounted display can be used, room capacity, and the like) can be checked. Each circle “◯” in the table 522 indicates a reservable time slot. The user can make a reservation request by selecting any one of these time slots.

FIG. 5D illustrates a reservation completion screen. The date of use, the viewing content, the reserved experiential content viewing room, and the reserved time slot are displayed. In addition, a reservation code 531 required when the user uses the experiential content viewing room is also displayed.

The subscriber can bring their own head-mounted display to the experiential content viewing room. In this case, a dedicated application for the head-mounted display is required to be installed. By selecting a link for a dedicated application guide 532, the subscriber can visit a site where details are described for setting up the dedicated application for the head-mounted display.

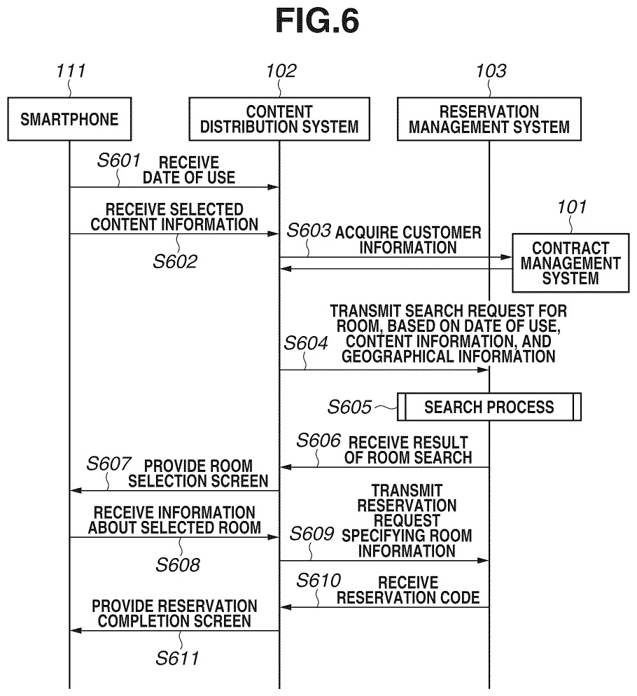

FIG. 6 illustrates a sequence of processing relating to the experiential content viewing room reservation illustrated in FIGS. 5A to 5D.

This sequence describes a process procedure executed by software modules implemented by executing software programs included in the systems of the content distribution service management system illustrated in FIG. 3.

In step S601, the content management unit 311 of the content distribution system 102 receives the date of use entered via the reservation screen in FIG. 5A. This input is executed based on a user operation via the web browser 351 of the smartphone 111.

In step S602, the content management unit 311 receives information about the content selected via the reservation screen in FIG. 5B. This input is executed based on a user operation via the web browser 351 of the smartphone 111 as in step S601. The content information includes identification information for identifying content data.

In step S603, the content management unit 311 requests the contract management system 101 to acquire customer information about the user who has logged in. The customer information acquired in this step includes geographical information corresponding to the customer's address registered as customer information. Step S603 is processing on the assumption that the “SEARCH NEAR REGISTERED ADDRESS” as the search 502 is selected on the reservation screen in FIG. 5A.

In step S604, the content management unit 311 transmits a search request for an experiential content viewing room to the reservation management system 103, the request including the date of use, the content information, and the geographical information.

In step S605, the reservation management unit 321 of the reservation management system 103 performs processing to search for experiential content viewing rooms that meet the conditions received in step S604. In the search processing, the room management unit 322 uses the geographical information to narrow down experiential content viewing rooms located near the geographical information. The room management unit 322 narrows the experiential content viewing rooms down to the experiential content viewing rooms having equipment that enables the experiential viewing of the content corresponding to the content information specified as the conditions. The reservation management unit 321 then checks the reservation status for the date of use of the narrowed experiential content viewing rooms to identify the experiential content viewing rooms having at least one reservable time slot. In this processing, there may be a case where no reservable experiential content viewing rooms are found.

In step S606, the content management unit 311 receives a result of the search processing based on the specified conditions from the reservation management unit 321. In this sequence, the three experiential content viewing rooms as illustrated in FIG. 5C are identified.

In a case where no reservable experiential content viewing rooms are found in step S605, a value indicating that there is no room information is returned to the content management unit 311 as the result of the search processing. The content management unit 311 provides a message “There are no rooms available for reservation” to the web browser 351 of the smartphone 111, and provides the reservation screen in FIG. 5A again to prompt the user to enter information again.

In step S607, the provision unit 313 provides to the web browser 351 of the smartphone 111 the screen illustrated in FIG. 5C for selecting an experiential content viewing room. This screen displays the list of rooms included in the search result received in step S606. In step S608, the content management unit 311 receives the room information and the time information selected by the user via the web browser 351 of the smartphone 111.

In step S609, the content management unit 311 transmits a reservation request that specifies the room information and the time information received in step S608 to the reservation management system 103. In step S610, the content management unit 311 receives from the reservation management system 103 reservation completion information together with the reservation code issued by the reservation management system 103. In step S611, as illustrated in FIG. 5D, the provision unit 313 provides the reservation completion screen, which includes the reservation code received in step S610, to the web browser 351 of the smartphone 111. In this manner, the user completes the reservation for the experiential content viewing room.

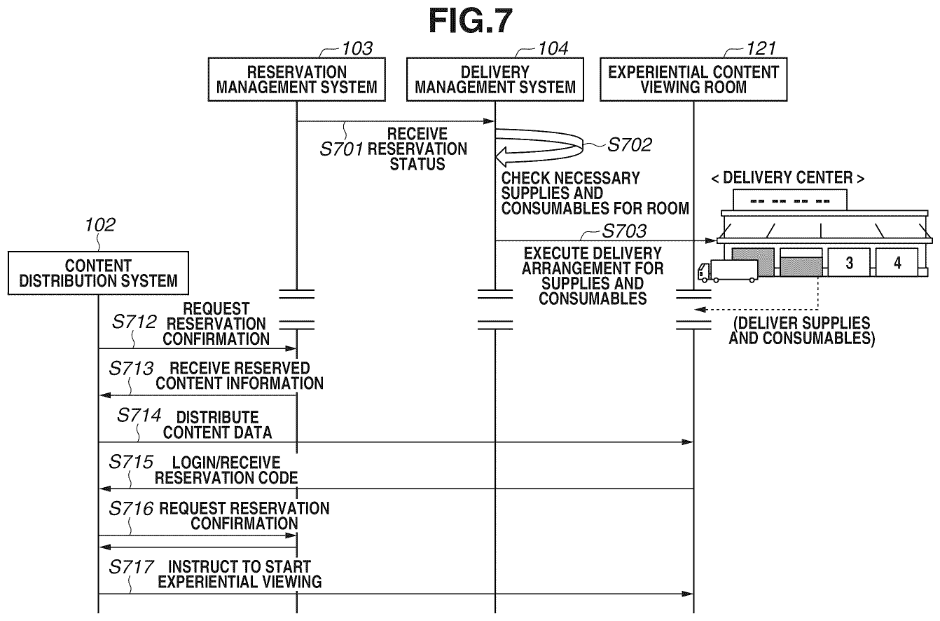

FIG. 7 illustrates a sequence of processing performed before the subscriber actually uses the experiential content viewing room.

The sequence in FIG. 7 is a process procedure executed by software modules implemented by executing software programs included in the systems of the content distribution service management system illustrated in FIG. 3.

In step S701, the delivery control unit 331 of the delivery management system 104 receives a reservation status from the reservation management system 103. This is based on a reservation status being notified each time a reservation is completed by the sequence in FIG. 6.

In step S702, the inventory management unit 332 checks necessary supplies and consumables for the experiential content viewing room to be used on the date of use based on the new reservation in the reservation status. In this step, the supplies and consumables necessary for the experiential viewing of the scheduled content for distribution are determined. In step S703, the delivery control unit 331 arranges delivery of the determined necessary supplies and consumables to the specified experiential content viewing room from a delivery center.

The delivery center delivers the supplies and consumables to the specified experiential content viewing room based on the delivery arrangement information.

In step S712, the distribution control unit 312 of the content distribution system 102 transmits a request for reservation confirmation to the reservation management system 103. This processing is executed every day at a certain time scheduled before a reserved time slot. In step S713, the distribution control unit 312 receives content information about each reserved experiential content viewing room from the reservation management system 103.

In step S714, the distribution control unit 312 executes processing to distribute content data for experiential viewing to the room control unit 362 of the respective experiential content viewing rooms based on the content information for each reserved experiential content viewing room. At this point, the preparation for the experiential viewing in the experiential content viewing room is completed.

In step S715, the user executes login processing by using the member-only application 363 for the head-mounted display in the experiential content viewing room at the reserved time slot. After the content management unit 311 receives the login request, the content management unit 311 also receives the reservation code entered by the user from the member-only application 363.

In step S716, the content management unit 311 transmits, to the reservation management system 103, a request for reservation confirmation with the reservation code specified. The reservation management system 103 refers to the reservation status, checks that the reservation corresponding to the reservation code is confirmed, and transmits a response indicating that the reservation is confirmed to the content management unit 311.

In step S717, the content management unit 311 transmits an instruction to start the experiential viewing to the room control unit 362 of the experiential content viewing room. In response to this instruction, the terminal control unit 361 and the room control unit 362 of the experiential content viewing room start providing the experiential viewing to the user in coordination with the head-mounted display.

### Application Example

In the search processing for a experiential content viewing room by the reservation management unit 321 of the reservation management system 103 in step S605 in FIG. 6, there may be a case where the user is unable to view specified content in an experiential content viewing room near the user's registered address because the supplies and consumables cannot be delivered in time before the date of use. Such a case may occur when the user selects the same day or the following day as the date of use.

As described above, in a case where no reservable experiential content viewing rooms are found in step S605, the content management unit 311 provides a message “There are no rooms available for reservation” to the web browser 351 of the smartphone 111. As an application example, the content management unit 311 can provide an option of “searching for content that can be viewed in an experiential content viewing room near the registered address on the same date of use” to the web browser 351 of the smartphone 111.

If the user selects this option, the content management unit 311 transmits a content search request including the date of use and the geographical information to the reservation management system 103.

The reservation management system 103 identifies experiential content viewing rooms based on the date of use and the geographical information to search for content information that is available for experiential viewing by using the room equipment including currently available supplies and consumables. The reservation management system 103 transmits a search result to the content management unit 311.

The content management unit 311 provides a list of content included in the search result to the web browser 351 of the smartphone 111 to prompt the user to select a piece of the content from the list. If the piece of the content is selected, the content management unit 311 provides a time slot reservation screen corresponding to FIG. 5C, which includes the experiential content viewing rooms in which the piece of the content can be viewed in experiential viewing. In the subsequent processing, the same steps as steps S608 to S611 in FIG. 6 will be executed.

According to the application example, when a user wishes to prioritize the date of use, such as on the day, and enjoy the experiential viewing, a system can be implemented that promptly responds to the user's needs.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-227751, filed Dec. 24, 2024, which is hereby incorporated by reference herein in its entirety.

What is claimed is:

1. A method for distributing content, the method comprising:
executing, based on receipt of a new reservation, a process of arranging delivery of supplies and consumables for the new reservation for an experiential content viewing room associated with the new reservation; and
receiving information about reserved content to perform distribution control of content data corresponding to the content information.

2. A content distribution service management system including a content distribution system, a reservation management system, and a delivery management system,
wherein the delivery management system is configured to execute, based on a new reservation received from the reservation management system, a process of arranging delivery of supplies and consumables for the new reservation for an experiential content viewing room for which the new reservation is made, and
wherein the content distribution service management system comprising:
one or more memories storing instructions; and
one or more processors which, when executing the instructions, cause the content distribution system to:
receive information about reserved content from the reservation management system; and
perform distribution control of content data corresponding to the content information.

3. The content distribution service management system according to claim 2,
wherein the reservation management system is configured to issue, for the new reservation, a reservation code to use an experiential content viewing room selected by a user, and
wherein, in a case where input of the reservation code by the user using an application in the experiential content viewing room is verified, experiential viewing using the content data, the supplies, and the consumables is started.

4. The content distribution service management system according to claim 2,
wherein the reservation management system is configured to perform search processing for an experiential content viewing room that is available to a user based on a date of use and geographical information specified by the user, and
wherein in the search processing, experiential content viewing rooms corresponding to the geographical information are narrowed down based on, in addition to the date of use and the geographical information, information about content that the user wishes to view.

5. The content distribution service management system according to claim 4, wherein the search processing further includes narrowing down to an experiential content viewing room having equipment that enables experiential viewing of the content corresponding to the content information.

6. The content distribution service management system according to claim 5, wherein in the search processing, from among the narrowed down experiential content viewing rooms, an experiential content viewing room having one or more reservable time slots is identified based on a reservation status on the date of use specified by the user.
